(19) United States
(12) Patent Application Publication
(10) Pub. No.: US 2016/0178044 A1
(43) Pub. Date: Jun. 23, 2016

(54) STRAIN WAVE GEARING DEVICE

(71) Applicant: HARMONIC DRIVE SYSTEMS INC., Tokyo (JP)

(72) Inventors: Noboru TAKIZAWA, Azumino-shi, Nagano (JP); Yuya MURAYAMA, Azumino-shi, Nagano (JP); Yoshihide KIYOSAWA, Azumino-shi, Nagano (JP)

(73) Assignee: HARMONIC DRIVE SYSTEMS INC., Shinagawa-ku, Tokyo, OT (JP)

(21) Appl. No.: 14/896,980

(22) PCT Filed: Jun. 19, 2014
(86) PCT No.: PCT/JP2014/066316

§ 371 Date: Dec. 9, 2015

(30) Foreign Application Priority Data
Jul. 1, 2013 (JP) PCT/JP2013/004077

(51) Int. Cl. F16H 49/00

(52) U.S. Cl. CPC F16H 49/001

(57) ABSTRACT

The externally toothed gear of the strain wave gear device is provided with first external teeth, which are capable of meshing with first internal teeth on the stationary side, and second external teeth, which are capable of meshing with second internal teeth on the driving side. The numbers of the first and second external teeth differ. The number of the first internal teeth is greater than the number of the first external teeth. The number of the second internal teeth is less than the number of the second external teeth. Using the externally toothed gear, which is provided with first and second external teeth that differ in number, a strain wave gear device with a low reduction ratio in which the velocity ratio is less than 30 can be achieved.

### TECHNICAL FIELD

The present invention relates to a strain wave gearing device comprising a pair of internally toothed gears, a radially flexible cylindrical externally toothed gear, and a wave generator.

### BACKGROUND ART

Flat-type strain wave gearing devices commonly comprise a stationary-side internally toothed gear fixed so as not to rotate, a wave generator which is a rotation-inputting element, a drive-side internally toothed gear which is a reduced-rotation-outputting element, and a radially flexible cylindrical externally toothed gear capable of meshing with the stationary-side internally toothed gear and the drive-side internally toothed gear. In typical strain wave gearing devices, the externally toothed gear is caused to flex into an ellipsoidal shape, and meshes with the stationary-side and drive-side internally toothed gears at positions on the two major-axis ends of the ellipsoidal shape.

Patent Document 1 discloses a common strain wave gearing device in which the stationary-side internally toothed gear has two more teeth than does the externally toothed gear, and the drive-side internally toothed gear has the same number of teeth as does the externally toothed gear. In the externally toothed gear, the external tooth portions that mesh with the stationary-side internally toothed gear and the external tooth portions that mesh with the drive-side internally toothed gear are separated in the tooth width direction. When the wave generator rotates, the externally toothed gear rotates at a reduced speed according to a speed ratio corresponding to the difference in the number of teeth with respect to the stationary-side internally toothed gear. The reduced rotation of the externally toothed gear is outputted from the drive-side internally toothed gear, which rotates integrally with the externally toothed gear.

Strain wave gearing devices can achieve a high reduction ratio, and have the feature of excellent responsiveness with no backlash. However, there are cases in which a strain wave gearing device having a low reduction ratio is desired, depending on the circumstances. In strain wave gearing devices, when the speed ratio is decreased, the radial flexibility of the externally toothed gear increases. In consideration of the mechanical characteristics, mechanical performance, and other factors pertaining to strain wave gearing reducers in which, e.g., an externally toothed gear meshes with an internally toothed gear while flexing, the speed ratio of the strain wave gearing reducers is commonly set to 50 or higher; obtaining a low speed ratio of less than 30, e.g., 20-15, is difficult.

Patent Document 2 discloses a strain wave gearing device in which the stationary-side internally toothed gear has two more teeth than does the externally toothed gear, and the drive-side internally toothed gear has two fewer teeth than does the externally toothed gear. In this strain wave gearing device, when the wave generator rotates, the externally toothed gear rotates at a reduced speed according to a speed ratio corresponding to the difference in the number of teeth with respect to the stationary-side internally toothed gear. The rotational speed of the externally toothed gear is increased at a speed ratio corresponding to the difference in the number of teeth between the externally toothed gear and the drive-side internally toothed gear, and is then outputted from the drive-side internally toothed gear. The rotation outputted from the drive-side internally toothed gear is a reduced rotation that is reduced at a speed ratio of less than 50 relative to the rotation inputted to the wave generator.

### PRIOR ART DOCUMENTS

### Patent Documents

Patent Document 1: JP-A 2011-112214
Patent Document 2: JP-A 02-275147

### SUMMARY OF THE INVENTION

### Problems to be Solved by the Invention

An object of the present invention is to provide a strain wave gearing device with which it is possible to easily realize a low speed ratio of less than 30.

### Means Used to Solve the Problems

The strain wave gearing device of the present invention is characterized in having:

a rigid first internally toothed gear in which first internal teeth are formed;

a rigid second internally toothed gear in which second internal teeth are formed, the second internally toothed gear being disposed so as to be coaxially aligned with the first internally toothed gear;

a flexible externally toothed gear in which first external teeth capable of meshing with the first internal teeth and second external teeth capable of meshing with the second internal teeth are formed on the outer peripheral surface of a radially flexible cylindrical body, the number of second external teeth being different than the number of first external teeth, and the externally toothed gear being disposed coaxially on the inner side of the first and second internally toothed gears; and

a wave generator which causes the externally toothed gear to radially flex, causing the first external teeth to partially mesh with the first internal teeth and causing the second external teeth to partially mesh with the second internal teeth,

the number of first external teeth being different from the number of first internal teeth, and the number of second external teeth being different from the number of second internal teeth.

In the present specification, a strain wave gearing device comprising an externally toothed gear in which first and second external teeth of differing number are formed on the outer peripheral surface of a flexible cylindrical body shall be referred to as a “dual-type strain wave gearing device.”

In the dual-type strain wave gearing device of the present invention, the speed ratio R1 between the first internally toothed gear and the externally toothed gear comprising the first external teeth, the speed ratio R2 between the second internally toothed gear and the externally toothed gear comprising the second external teeth, and the speed ratio R of the strain wave gearing device are represented as follows, where Zc1 is defined as the number of first internal teeth, Zc2 as the number of second internal teeth, Zf1 as the number of first external teeth, and Zf2 as the number of second external teeth:

R1=1/((Zf1−Zc1)/Zf1)

R2=1/((Zf2−Zc2)/Zf2)

R=(R1×R2−R1)/(−R1+R2)

According to the dual-type strain wave gearing device of the present invention, it is possible to obtain a speed ratio of less than 50; e.g., a speed ratio considerably below 30. This dual-type strain wave gearing device differs from the prior art in that first external teeth and second external teeth of differing number and module are formed as the external teeth of the externally toothed gear. Accordingly, there is a high degree of freedom in designing the speed ratio setting, and a strain wave gearing device having a low speed ratio can be realized more easily than in the prior art.

Typically, the number Zf1 of first external teeth is different from the number Zc1 of first internal teeth, and the number Zf2 of second external teeth is different from the number Zc2 of second internal teeth. For example, the number Zf1 of first external teeth can be less than the number Zc1 of first internal teeth, and the number Zc1 of first internal teeth can be equal to the number Zc2 of second internal teeth.

The wave generator serves as a rotation-inputting element, and either the first internally toothed gear or the second internally toothed gear serves as a stationary-side internally toothed gear fixed so as not to rotate, while the other serves as a drive-side internally toothed gear which is a reduced-rotation-outputting element.

The externally toothed gear is caused by the wave generator to flex into an ellipsoidal, three-lobed configuration, or other non-cylindrical shape. This causes the externally toothed gear to mesh with the rigid internally toothed gears at a plurality of positions that are separated in the circumferential direction. The externally toothed gear is commonly caused to flex into an ellipsoidal shape, meshing at two locations (the two end positions on the major axis of the ellipsoidal shape) separated by 180° in the circumferential direction. In such cases, the difference between the number Zf1 of first external teeth and the number Zf2 of second external teeth is equal to 2n, where n is defined as an integer.

### BRIEF DESCRIPTION OF THE DRAWINGS

FIG. 1 is an end view, a longitudinal cross-sectional view, and a partial enlarged cross-sectional view of a dual-type strain wave gearing device to which the present invention is applied; and

FIG. 2 is a schematic drawing of the dual-type strain wave gearing device shown in FIG. 1.

### MODE FOR CARRYING OUT THE INVENTION

An embodiment of a dual-type strain wave gearing device to which the present invention is applied is described below with reference to the drawings.

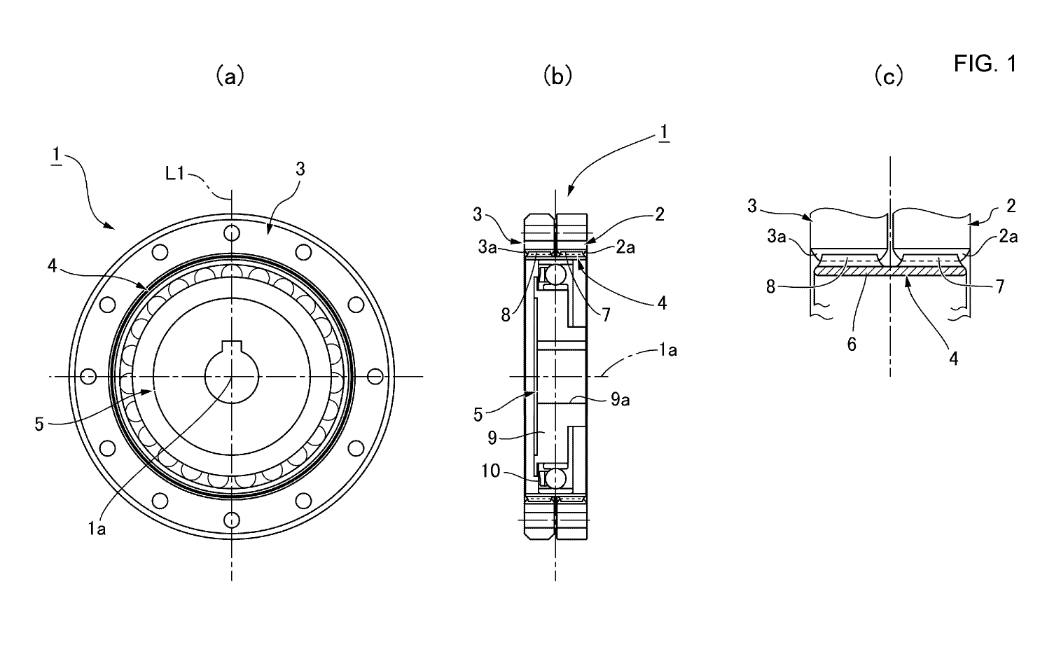

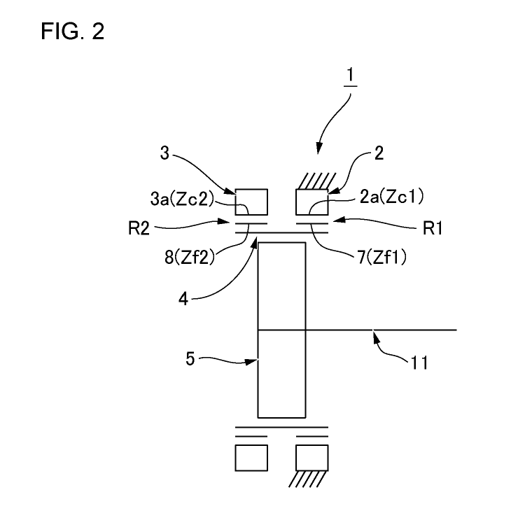

FIG. 1 is an end view, a longitudinal cross-sectional view, and a partial enlarged cross-sectional view of a dual-type strain wave gearing device (referred to below simply as “strain wave gearing device”) according to an embodiment of the present invention, and FIG. 2 is a schematic drawing of the same. The strain wave gearing device 1 is used as a reducer for example, and comprises a rigid annular first internally toothed gear 2, a rigid annular second internally toothed gear 3, a radially flexible cylindrical externally toothed gear 4, and an ellipsoidally contoured wave generator 5.

The first and second internally toothed gears 2, 3 are disposed in parallel, with a slight gap therebetween, in the direction of a center axis line 1a. The first internally toothed gear 2 is a stationary-side internally toothed gear fixed so as not to rotate, and the number of first internal teeth 2a thereof is represented by Zc1. The second internally toothed gear 3 is a rotatably supported drive-side internally toothed gear, and the number of second internal teeth 3a thereof is represented by Zc2. The second internally toothed gear 3 is a reduced-rotation-outputting element in the strain wave gearing device 1.

The externally toothed gear 4 is disposed coaxially on the inner side of the first and second internally toothed gears 2, 3. The externally toothed gear 4 comprises a radially flexible cylindrical body 6, and first external teeth 7 and second external teeth 8 formed on the circular outer peripheral surface of the cylindrical body 6. The first external teeth 7 are formed on one side of the circular outer peripheral surface of the cylindrical body 6 in the direction of the center axis line 1a, and the second external teeth 8 are formed on the other side.

Specifically, the first external teeth 7 are formed on the side that opposes the first internal teeth 2a, and are capable of meshing with the first internal teeth 2a, the number of first external teeth 7 being represented by Zf1. The second external teeth 8 are formed on the side that opposes the second internal teeth 3a, and are capable of meshing with the second internal teeth 3a, the number of second external teeth 8 being represented by Zf2. The numbers Zf1, Zf2 of teeth differ from each other. The first external teeth 7 and the second external teeth 8 are slightly separated in the direction of the center axis line 1a.

The wave generator 5 comprises an ellipsoidally contoured rigid plug 9, and a wave bearing 10 fitted onto the ellipsoidal outer peripheral surface of the rigid plug 9. The wave bearing 10 is a ball bearing comprising radially flexible inner and outer races. The wave generator 5 is inserted into the inner peripheral surface of the cylindrical body 6 of the externally toothed gear 4, and causes the externally toothed gear 4 to flex into an ellipsoidal shape. The ellipsoidally flexed externally toothed gear 4 meshes with the first and second internally toothed gears 2, 3 at the two end positions on the major axis L1 of the ellipsoidal shape. Specifically, the first external teeth 7 mesh with the first internal teeth 2a at the two end positions on the major axis L1, and the second external teeth 8 mesh with the second internal teeth 3a at the two end positions on the major axis.

The wave generator 5 is a rotation-inputting element in the strain wave gearing device 1. The rigid plug 9 of the wave generator 5 comprises a shaft hole 9a, and an input rotation shaft 11 (see FIG. 2) is fixed in a coaxial manner thereto. For example, a motor output shaft may be fixed thereto. When the wave generator 5 rotates, the positions at which the first external teeth 7 of the externally toothed gear 4 and the stationary-side first internal teeth 2a mesh, and the positions at which the second external teeth 8 of the externally toothed gear 4 and the drive-side second internal teeth 3a mesh, move along the circumferential direction.

The number Zf1 of first external teeth 7 and the number Zf2 of second external teeth 8 differ from each other; in the present example, the number Zf2 of second external teeth is greater. Additionally, the number Zc1 of first internal teeth 2a is different from the number Zf1 of first external teeth 7; in the present example, the number Zc1 of first internal teeth 2a is greater. The number Zc2 of second internal teeth 3a and the number Zf2 of second external teeth 8 differ from each other; in the present example, the number Zc2 of second internal teeth 3a is less.

In the present example, the externally toothed gear 4 is caused to flex into an ellipsoidal shape, and meshes with the internally toothed gears 2, 3 at two locations along the circumferential direction. Therefore, the difference between the number Zf1 of first external teeth 7 and the number Zf2 of second external teeth 8 is equal to 2n₀, where n₀ is defined as a positive integer. Similarly, the difference between the number Zc1 of first internal teeth 2a and the number Zf1 of first external teeth 7 is equal to 2n₁, where n₁ is defined as a positive integer. The difference between the number Zc2 of second internal teeth 3a and the number Zf2 of second external teeth 8 is equal to 2n₂, where n₂ is defined as a positive integer.

Zf1=Zf2+2n₀

Zc1=Zf1+2n₁

Zc2=Zf2−2n₂

In a specific example, the numbers of teeth are set as follows (n₀=n₁=n₂=1):

Zc1=62

Zf1=60

Zc2=62

Zf2=64

The speed ratio R1 between the first internally toothed gear 2 and the first external teeth 7, and the speed ratio R2 between the second internally toothed gear 3 and the second external teeth 8, are thus as follows:

i1=1/R1=(Zf1−Zc1)/Zf1=(60−62)/60=−1/30

i2=1/R2=(Zf2−Zc2)/Zf2=(64−62)/64=1/32

### Therefore, R1=−30, and R2=32.

The speed ratio R of the strain wave gearing device 1 is represented by the following formula using the speed ratios R1 and R2. Accordingly, according to the present invention, a strain wave gearing device having a considerably low speed ratio (low reduction ratio) can be realized. (A negative speed ratio indicates that output rotation progresses in the direction opposite that of input rotation.)

$$\begin{matrix}R = ( R 1 \times R 2 - R 1 ) / ( - R 1 + R 2 ) \\ = ( - 30 \times 32 + 30 ) / ( 30 + 32 ) \\ = - 930 / 62 \\ = - 15\end{matrix}$$

### Other Embodiments

In the examples shown in FIGS. 1 and 2, the first internally toothed gear 2 is a stationary-side internally toothed gear, and the second internally toothed gear 3 is a drive-side internally toothed gear. However, it is also possible to achieve a configuration in which the first internally toothed gear 2 is a drive-side internally toothed gear and the second internally toothed gear 3 is a stationary-side internally toothed gear.

Additionally, the externally toothed gear 4 can be caused by the wave generator 5 to flex into a non-cylindrical shape other than an ellipsoid; e.g., into a three-lobe configuration or other non-cylindrical shape. The difference in the number of teeth between the non-cylindrically flexed externally toothed gear and the internally toothed gear may be set to h×p, where h is defined as the number of locations at which the two gears mesh (h being a positive integer equal to or greater than 2, and p being a positive integer).

1. A dual type strain wave gearing device comprising:
a rigid first internally toothed gear formed with first internal teeth;
a rigid second internally toothed gear formed with second internal teeth, the second internally toothed gear being disposed so as to be coaxially aligned with the first internally toothed gear;
a flexible externally toothed gear disposed on an inner side of the first and second internally toothed gears, in which first external teeth capable of meshing with the first internal teeth and second external teeth capable of meshing with the second internal teeth are formed on an outer peripheral surface of a radially flexible cylindrical body of the flexible externally toothed gear, and the number of the second external teeth being different than the number of the first external teeth; and
a wave generator for radially flexing the externally toothed gear to cause the first external teeth to partially mesh with the first internal teeth and to cause the second external teeth to partially mesh with the second internal teeth, wherein
the number of the first external teeth is different from the number of the first internal teeth, and the number of the second external teeth is different from the number of the second internal teeth.

2. The strain wave gearing device according to claim 1, wherein
the number of the first external teeth is less than the number of the first internal teeth, and
the number of the first internal teeth is equal to the number of the second internal teeth.

3. The strain wave gearing device according to claim 1, wherein
the wave generator is a rotation-inputting element, and
one of the first internally toothed gear and the second internally toothed gear is a stationary-side internally toothed gear fixed so as not to rotate, while the other is a drive-side internally toothed gear which is a reduced-rotation-outputting element.

4. The strain wave gearing device according to claim 1, wherein
the wave generator flexes the externally toothed gear into an ellipsoidal shape to mesh the first external teeth partially with the first internal teeth at two locations in the circumferential direction and to mesh the second external teeth partially with the second internal teeth at two locations in the circumferential direction, and
a difference between the number of the first external teeth and the number of the second external teeth is 2n where n is an integer.
